(19) United States
(12) Patent Application Publication
(10) Pub. No.: US 2012/0026272 A1
(43) Pub. Date: Feb. 2, 2012

(54) OPTICAL IMAGING SYSTEM

(75) Inventors: Yigal Katzir, Rishon Lezion (IL); Elie Meimoun, Jerusalem (IL)

(73) Assignee: ORBOTECH LTD., Yavne (IL)

(21) Appl. No.: 13/262,764

(22) PCT Filed: Apr. 22, 2010
(86) PCT No.: PCT/IL10/00320

§ 371 Date: Oct. 3, 2011

(30) Foreign Application Priority Data
May 12, 2009 (IL) 198719

(51) Int. Cl. B41J 2/47

(52) U.S. Cl. 347/239

(57) ABSTRACT

A method of scanning a pattern on a surface, the method comprises forming a first spatially modulated light beam including a pattern for writing on a surface; splitting the first spatially modulated light beam into a plurality of sub-beams; altering a spatial relationship between the plurality of sub-beams, thereby forming a second spatially modulated light beam; and canning the surface with the second spatially modulated light beam.

### FIELD OF THE INVENTION

The present invention relates to imaging. An important application of the invention is to Direct Imaging (DI) of Printed Circuit Boards (PCB), and more particularly to optical systems used in DI.

### BACKGROUND OF THE INVENTION

In a well known class of DI systems, a spatial light modulator (SLM) such as a Digital Micro-Mirror Device (DMD) or liquid crystal light valve is used for spatially modulating a beam to form the image or pattern to be printed. DMDs are SLMs in which the modulating elements are comprised of several hundred thousand microscopic mirrors arranged in a rectangular array including rows and columns. As used herein the rows and the columns in the rectangular array are defined such that the rows include more modulating elements than the columns. Each of the mirrors in the array can be individually rotated to an ON or OFF state. In the ON state, light from the light source is reflected into the optical system directing light toward the writing surface and in the OFF state, the light is directed away from the writing surface, e.g. into a light trap or heat sink.

Although DMDs are used in direct imaging, they are primarily intended to be used for digital light processing projectors and rear projection televisions. The aspect ratio of the rectangular array is therefore configured for standard picture formats, e.g. television and projector screens.

Typically, the width of a panel to be scanned in DI is much wider than the width of the image produced by a standard DMD. In some systems, the DI includes a single or otherwise few DMDs and image stepping or stitching is used to scan the entire width of the panel. Alternatively, a series of DMDs are used to allow scanning in a single pass.

U.S. Pat. No. 6,903,798 entitled “Pattern Writing Apparatus and Pattern Writing Method” assigned to Dainippon Screen Mfg. Co., Ltd., the contents of which is incorporated herein by reference, describes a DMD within a writing apparatus where the arrangement of the irradiation regions of the DMD is tilted relative to the main scan direction. A center-to-center distance along the sub-scan direction between two adjacent irradiation regions arranged in the main scan direction is made equal to a pitch of writing cells on the substrate with respect to the sub-scan direction. ON/OFF control of light irradiation of each irradiation region is performed each time the irradiation regions move a distance equal to twice a pitch.

US Patent Application Publication No. US20060269217 entitled “Pattern Writing Apparatus and Block Number Determining Method” assigned to Dainippon Screen Mfg. Co., Ltd., the contents of which is incorporated herein by reference, describes a pattern writing apparatus comprising a DMD for spatially modulating light and directing modulated light beams to a plurality of irradiation regions. In the DMD, writing signal is sequentially inputted to mirror blocks to be used out of a plurality of mirror blocks corresponding to the plurality of irradiation blocks, respectively. When writing a pattern, an operation part determines the number of mirror blocks to be used where scan speed can be maximized, in consideration of required time for input of the writing signal to the DMD and light amount applied on the substrate.

### SUMMARY OF THE INVENTION

An aspect of some embodiments of the invention is the provision of systems and methods for optically manipulating spatial distribution of data obtained from a SLM.

An aspect of some embodiments of the present invention provides for a method of scanning a pattern on a surface, the method comprising: forming a first spatially modulated light beam including a pattern for writing on a surface; splitting the first spatially modulated light beam into a plurality of sub-beams; altering a spatial relationship between the plurality of sub-beams, thereby forming a second spatially modulated light beam; and scanning the surface with the second spatially modulated light beam.

Optionally, the scanning includes writing.

Optionally, altering the spatial relationship between the plurality of sub-beams alters the aspect ratio of the first spatially modulated light beam.

Optionally, altering the spatial relationship between the plurality of sub-beams provides a spatially modulated light beam that is elongated with respect to the first spatially modulated light beam.

Optionally, the spatial relationship between the plurality of sub-beams is altered to provide over-lap between sub-beams in the cross-scan direction during the scanning.

Optionally, the over-lap provides for writing the pattern with a resolution greater than a resolution provided by the first spatially modulated light beam.

Optionally, the spatial relationship between the plurality of sub-beams is altered to form a plurality of rows of sub-beams that at least partially over-lap in a scan direction during the scanning.

Optionally, the plurality of rows are shifted with respect to each other by a distance equivalent to width of half an SLM element.

Optionally, the spatial relationship between the plurality of sub-beams is altered to form a plurality of columns of sub-beams that at least partially over-lap in a scan direction during the scanning.

Optionally, the spatially relationship between the plurality of sub-beams is altered to form a compact polygonal spatial relationship.

Optionally, the method comprises altering angular orientation of at least a portion of the plurality of sub-beams.

Optionally, the spatial relationship between the plurality of sub-beams is altered to form at least a first and a second row, wherein sub-beams of the first row have a first angular orientation and sub-beams of the second row have a second angular orientation different than the first angular orientation, and wherein the first row and the second row over-lap each other during scanning.

Optionally, the difference between the angular orientation of sub-beams in the first and the second row is 45 degrees.

Optionally, the method comprises directing each of the plurality of sub-beams in a direction perpendicular to the surface.

Optionally, each of the plurality of sub-beams is directed toward the surface with a telecentric lens.

Optionally, splitting of the spatially modulated light beam into a plurality of sub-beams is provided by a plurality of reflective or refractive surfaces.

Optionally, the plurality of reflective or refractive surfaces is provided on a single optical element.

Optionally, the splitting of the spatially modulated light beam into a plurality of sub-beams and the altering of the spatial relationship between the plurality of sub-beams is provided by a single optical element including a plurality of surfaces.

Optionally, the spatially modulated light beams are formed with a Digital Micro-mirror Device (DMD), wherein the DMD includes rows and columns of reflecting elements, wherein the rows contain more elements than the columns.

Optionally, each of the plurality of sub-beams corresponds to light reflected from a plurality of neighboring rows of the DMD.

Optionally, the spatial relationship between the plurality of sub-beams is altered from a first modulated light beam divided into an array of a plurality of rows to form the second spatially modulated light beam wherein the sub-beams are spatially arranged side by side to form at least one elongated row of modulated beams.

Optionally, the sub-beams are optically rotated.

Optionally, the second spatially modulated light beam is formed from at least two rows of sub-beams, wherein the first and second rows are shifted with respect to each other by half the length of one reflective element of the DMD.

Optionally, the method comprises blanking a portion of the DMD between the plurality of neighboring rows.

Optionally, the portion of the DMD that is blanked corresponds to portion determined to suffer from vignetting or obstruction effects due to the splitting.

Optionally, each of the plurality of sub-beams is reflected from the same number of neighboring rows.

Optionally, the surface is a surface of a panel of a printed circuit board, wherein the width of the panel in the cross-scan direction is wider than the width of the first spatially modulated light beam.

Optionally, the method comprises scanning the width of the panel in the cross-scan direction during a single pass.

Optionally, the surface advances in a scan direction during the scanning.

An aspect of some embodiments of the present invention provides for a system for scanning a pattern on a surface with a light beam comprising: a light source configured to generate a beam for scanning a pattern on a surface; a spatial light modulator configured for spatially modulating the beam to form a spatially modulated beam providing the pattern to be written on the surface; a beam splitting element configured for spatially dividing the modulated beam into a plurality of sub-beams; a scanner operative to scan a target object with the plurality of redirected sub-beams; and a controller operative to provide a modulation signal to the SLM complying with the splitting of the modulated beam.

Optionally, the system comprises a redirecting element configured for altering a spatial relationship between the sub-beams and wherein the controller is operative to provide a modulation signal to the SLM complying with the redirecting of the sub-beams.

Optionally, the beam splitting element is configured to alter the aspect ratio of the spatially modulated beam.

Optionally, the beam splitting element is configured to provide a second spatially modulated beam that is elongated with respect to the spatially modulated beam.

Optionally, the beam splitting element is configured for providing overlapping regions between sub-beams during scanning.

Optionally, the spatially light modulator is a DMD, wherein the DMD includes rows and columns of reflecting elements.

Optionally, the beam splitting element is configured to form each sub-beams from light reflected from a plurality of neighboring rows of the DMD, wherein the rows of the DMD are longer than the columns of the DMD.

Optionally, a portion of the DMD between the plurality of neighboring rows is blanked.

Optionally, the portion of the DMD that is blanked corresponds to portion determined to suffer from vignetting or obstruction effects due to splitting of the modulated beam.

Optionally, the portion corresponds to 20 to 30 rows of the DMD.

Optionally, each of the plurality of sub-beams is reflected from the same number of neighboring rows.

Optionally, the beam splitting element includes a plurality of reflective or refractive surfaces, each reflective or refractive surface reflecting one of the plurality of sub-beams.

Optionally, the plurality of reflective or refractive surfaces are arranged in a row and wherein the reflective or refractive surfaces arranged in the beginning and end of the row have a larger surface area than the surface area of the reflective or refractive surfaces arranged in the middle of the row.

Optionally, the system comprises an imaging system configured for focusing each sub-beam onto the target object.

Optionally, the imaging system includes at least one telecentric lens for directing each of the plurality of sub-beams on the target object in a direction perpendicular to the target object.

Optionally, the beam splitting element is straddled on a focal plane of the spatial light modulator.

Optionally, a primary imaging system configured for focusing the spatially modulated light beam on the beam splitting element.

Optionally, the beam splitting element is positioned on a focal plane of the primary imaging system.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a simplified schematic diagram of an optical system for splitting a spatially modulated beam into defined sub-beams and directing at least a portion of the sub-beams to different destinations in accordance with some embodiments of the present invention;

FIG. 2 shows a simplified schematic diagram of an image divided into defined sections, each section directed to a different destination in accordance with some embodiments of the present invention;

FIG. 3 shows a simplified flow chart of an exemplary method for partitioning a spatially modulated light beam into sub-beams and directing each sub-beam to a desired destination in accordance with some embodiments of the present invention;

FIG. 4 shows an exemplary beam splitting element in accordance with some embodiments of the present invention;

FIG. 5 shows a simplified schematic diagram of an image produced on a DMD, divided into slices and arranged to form an elongated rectangular image on a target object in accordance with some embodiments of the present invention;

FIG. 6 shows a simplified schematic diagram of image slices arranged on a target object to form an overlapping region in the cross-scan direction in accordance with some embodiments of the present invention;

FIG. 7 shows a simplified schematic diagram of image slices from two DMDs arranged to scan a full width of a panel in accordance to some embodiments of the present invention;

FIG. 8A shows a simplified schematic diagram of a DMD image divided into 4 image slices in accordance with some embodiments of the present invention;

FIG. 8B shows a simplified schematic diagram of two image slices from the DMD projected on a target surface with a half a pixel shift in the scan direction in accordance with some embodiments of the present invention;

FIG. 8C shows a simplified schematic diagram of two other image slices from the DMD projected on a target surface with a half a pixel shift in the cross-scan direction in accordance with some embodiments of the present invention;

FIG. 8D shows a simplified schematic diagram of the four image slices from the DMD projected on a target surface with a half a pixel shift in both the scan and cross-scan direction in accordance with some embodiments of the present invention;

FIG. 8E shows a simplified schematic diagram of four pixels from the DMD that are projected onto a target surface with half a pixel shift in both the scan and cross-scan direction in accordance with some embodiments of the present invention;

FIG. 9A shows a simplified schematic diagram of an optical system for splitting a spatially modulated beam that is angled with respect to the scan and cross-scan direction into defined sub-beams in accordance with some embodiments of the present invention;

FIG. 9B shows a simplified schematic diagram of image slices from a DMD that are angled with respect to the scan and cross-scan direction arranged to scan a width of a panel in accordance to some embodiments of the present invention;

FIG. 10 shows a simplified schematic diagram of sub-beams arranged on a target object at different angles with respect to the scan and cross-scan direction in accordance with some embodiments of the present invention;

FIG. 11A shows a simplified schematic diagram of two sets of sub-beams scanned on a target object with a 45 degree angle between them in accordance with some embodiments of the present invention;

FIG. 11B shows a simplified schematic diagram of a resultant pixel imaged on a target surface constructed from two angled DMD pixels in accordance with some embodiments of the present invention;

FIG. 12 shows a simplified schematic diagram of an optical system for splitting a spatially modulated beam into a plurality of sub-beams that are arranged to form an honeycomb compact array of sub-beams on a target object in accordance with some embodiments of the present invention;

FIG. 13 shows a simplified schematic diagram of image slices scanned in a compact honeycomb form in accordance with some embodiments of the present invention;

FIG. 14 shows a simplified schematic diagram of two pixels from an image slice on a DMD in accordance with some embodiments of the present invention;

FIG. 15A shows a simplified schematic diagram of projections of two pixels on a beam splitting element in accordance with some embodiments of the present invention;

FIG. 15B shows a simplified schematic diagram of reflection of beams from two pixels on a beam splitting element in accordance with some embodiments of the present invention;

FIG. 16 shows a simplified schematic diagram of blanked areas on a DMD proximal to edges of image slices in accordance with some embodiments of the present invention;

FIG. 17 shows a simplified schematic diagram of a modified beam splitting element in accordance with some embodiments of the present invention;

FIG. 18 shows a simplified monolithic block that functions to split a spatially modulated light beam into sub-beams and to direct the sub-beams to a specified direction in accordance with some embodiments of the present invention;

FIG. 19A shows a simplified schematic diagram of an optical system for splitting a spatially modulated beam into defined sub-beams and for directing at least a portion of the sub-beams to different target objects in accordance with some embodiments of the present invention;

FIG. 19B shows a simplified schematic diagram of an image divided into defined sections, each section directed to a different destination including different target objects in accordance with some embodiments of the present invention; and

FIG. 20 shows a simplified schematic diagram of a maskless lithography system for exposing a pattern on a PCB panel in accordance with some embodiments of the present invention.

### DESCRIPTION OF SPECIFIC EMBODIMENTS OF THE INVENTION

The present invention relates to imaging. An important application of the invention is to Direct Imaging (DI) of Printed Circuit Boards (PCB), and more particularly to optical systems used in DI.

As used herein the scan direction refers to the direction the target object advances during a single pass, while the cross-scan direction refers to a direction substantially perpendicular to the scan direction. In case of multi-pass scanning, stepping between passes will be done in the cross scan direction.

The present inventor has found that the aspect ratio of a standard DMD is not well-suited for the dimensions of typical panels that are scanned to manufacture PCBs. Image stepping significantly increases production time and thereby increases production cost due to the multiple passes that are required. In addition, potential mismatching between the passes may introduce additional errors. Scanning with a plurality of DMDs to allow single pass scanning results in additional system cost due to the cost of the DMD and its associated mechanical, optical, computing and electronic parts and subassemblies, and thereby also increases cost of production of PCB.

An aspect of some embodiments of the present invention is the provision of a system and method for partitioning a spatially modulated light beam into smaller sub-beams each arising from a different spatial origin on the SLM, and separately directing each of the sub-beams to a desired position and incidence angle on one or more objects. According to some embodiments of the present invention, the optical partitioning and diverting provides for optically manipulating data distribution output from a DMD. According to some embodiments of the present invention, optically partitioning and diverting of the spatially modulated beam provides for optically altering the aspect ratio of the spatially modulated light beam. In some exemplary embodiments, the altered spatially modulated light beam is used to scan a continuous image onto a surface that moves in a scan direction with respect to the light beam.

According to some embodiments of the present invention, the beam is partitioned so that each of the sub-beams corresponds to light reflected by a sub-group of mirrors, e.g. pixels, of the DMD. In some exemplary embodiments, each sub-beam includes light reflected off one or more rows or columns of the DMD.

According to some exemplary embodiments, the sub-beams are redirected and/or re-distributed to form a longer and thinner scanning beam. In some exemplary embodiments, the sub-beams are redistributed to form a single line of sub-beams. In other exemplary embodiments, the sub-beams are redirected to form a plurality of sub-beams lines. In some exemplary embodiments, the sub-beams are optically directed to be parallel to each other and impinge perpendicularly on a target surface. In some exemplary embodiments, the sub-beams are angled with respect to the scan direction. In some exemplary embodiments, angling the sub-beam with respect to the scan direction provide for increasing the resolution of the scanned image. In some exemplary embodiments, the sub-beams are optically arranged side-by-side on the panel, e.g. in a row, with gaps in between. In some exemplary embodiments, the sub-beams are optically arranged in two or more rows including gaps to form a checkered pattern with the sub-beams partially overlapping in the cross-scan direction. The present inventor have found that by partitioning and spatially re-arranging and/or re-distributing the sub-beams, it is possible to form an altered spatially modulated beam that is longer and thinner than the original spatially modulated beam. The altered spatially modulated beam can be used to scan a panel in relatively few passes, e.g. a single pass, a double pass, or quadruple pass. As used herein, rows refer to a direction generally parallel to the cross-scan direction and columns refer to a direction generally parallel to, a scan direction.

According to some embodiments of the present invention, the sub-beams are redirected and/or re-distributed to form over-lapping regions during a single pass. In some exemplary embodiments, overlapping regions provide for increasing the resolution of the scanned image. In some exemplary embodiments, the overall pixel density is increased. In some exemplary embodiments, the pixel density at one or more angles is increased. In some exemplary embodiments, overlapping regions are provided over a plurality of passes.

According to some embodiments of the present invention, during scanning of a first pass, a first series of sub-beams scans a panel leaving gaps in the printed pattern and during a second pass, a second series of sub-beams scan the panel to fill the gaps left by the first pass. In some exemplary embodiments, the PCB is moved in the cross-scan direction to align the scan of the second series with the scan of the first series. In some exemplary embodiments, during a second pass, the second series of sub-beams scan the gap areas as well as overlapping regions surrounding the gaps. The present inventor have found that scanning the gap areas together with surrounding areas that overlap areas that were previously scanned improves integration between images formed by each of the sub-beams. In some exemplary embodiments, more than two passes are implemented to complete scanning of the panel. For example, the space between the sub-beams in the first set is approximately twice the width of the sub-set in the cross-scan direction.

According to some embodiments of the present invention, portions of the sub-beams are optically rotated, e.g. rotated without physically rotating a DMD, and scanned at an angle with respect to the scan and cross-scan direction. According to some exemplary embodiments, a first portion of the sub-beams are scanned at a first angle with respect to the cross-scan direction and a second portion of the sub-beams are scanned at a second different angle with respect to the cross-scan direction. In some exemplary embodiments, the first portion and the second portion are scanned at a 45 degree angle from each other.

According to some embodiments of the present invention, the spatially modulated light beam is partitioned by a splitting element(s) containing a plurality of splitting surfaces.

Splitting elements may be reflective or refractive elements. In some exemplary embodiments, the splitting element includes a plurality of mirrors, each positioned at a different angle. In some exemplary embodiments, the splitting element is a prism having a plurality of reflecting surfaces. In some exemplary embodiments, the splitting element is straddled around the focal plane of the DMD to avoid vignetting effect and/or beam mixing.

The present inventors have found that portions of each of the sub-beams configured for impinging the splitting surfaces near its edges may suffer from vignetting and obstruction effects. Typically, vignetting and obstruction effects are due to the physical structure of the splitting element. For example, some parts of the splitting element may be out of the focal plane and some of the edges of the splitting surfaces may cut part of adjacent sub-beam. According to some embodiments of the present invention, vignetting along the outer edges of the splitting element is avoided by enlarging the area of the outer surfaces of the splitting element to exceed the area of the impinging sub-beam. According to embodiments of the present invention, vignetting and obstruction along edges of splitting surface that neighbors other splitting surfaces are avoided by blanking portions of the DMD that are to be reflected toward edges of the splitting surfaces. As used herein the term blanking refers to turning off a pixel(s) of a DMD and/or an elementary element(s) of a SLM. According to some embodiments of the present invention, the blanking pattern is defined to maximize the usable area corresponding to each sub-beam while minimizing the ambiguity due to vignetting and obstruction effects. According to some embodiments of the present invention, the blanking pattern is defined to provide uniform power output from each of the sub-beams.

Typically, in response to splitting a light beam into sub-beams, the sub-beams are dispersed from the splitting element at different angles. This may result in oblique incidence of light on photoresist on the PCB, which degrades the quality and/or system performance. During DI, it is generally advantageous for all the sub-beams to impinge the photoresist surface perpendicularly. When the scanning beam impinges at a non-perpendicular angle, the quality is compromised. According to some embodiments of the present invention, one or more optical elements are included to align each of the sub-beams to hit the target object head-on, i.e., perpendicular to the surface.

According to some embodiments of the present invention, each sub-beam is directed toward an optical sub-system including one or more optical elements. In some exemplary embodiments the optical sub-system includes an imaging system containing one or more elements, such as lenses to direct the sub-beams along an angle perpendicular to the panel. In some exemplary embodiments, the sub-beam optical system includes a pair of telecentric lenses. In some exemplary embodiments, the sub-beam optical system includes one or more redirecting elements, to redirect at least a portion of the sub-beams to a specified position and direction as well as to bring it to a proper focus.

In some exemplary embodiments, the redirecting elements function to direct the sub-beams to different areas in an object, e.g. a flat surface such as a PCB or other panel. In some exemplary embodiments, the redirecting elements function to direct at least a portion of the sub-beams toward different objects or toward a three dimensional object. In some exemplary embodiments, the redirecting element functions to direct the sub-beams toward one or more objects in a direction perpendicular to the impinged area. In some exemplary embodiments, the spatially modulated beam is directed toward a primary imaging system prior to being split. In some exemplary embodiments, the splitting element is straddled on the focal plane of the primary imaging system.

Reference is now made to FIG. 1 showing a simplified schematic diagram of an optical system for splitting a spatially modulated beam into defined sub-beams and directing the sub-beams to different positions on a surface in accordance with some embodiments of the present invention. According to some embodiments of the present invention, a spatially modulated beam 190 is formed when incident beam 105 impinges on SLM 110. In some exemplary embodiments, SLM 110 is a DMD. Optionally, prior to splitting, beam 190 passes through a primary imaging system 120 that re-images SLM 110 onto a splitting element 130. Beam 190 is reflected or refracted off beam splitting element 130 to divide the beam into a plurality of sub-beams 195. In various exemplary embodiments, beam splitter 130 can be constructed from mirrors, prisms, lenses or other general optics that change the direction of the light.

In some exemplary embodiments, splitting element 130 is straddled on and/or around the focal plane of SLM 110. The present inventor has found that straddling the splitting element 130 on the focal plane reduces unusable parts of the SLM due to non-continuity between the basic elements of beam splitter 130. In some exemplary embodiments, straddling the beam splitting element 130 on and/or around the focal plane of the SLM reduces vignetting effects and avoids beam mixing. Typically, when primary imaging system 120 is included, beam splitting element 130 is positioned on the focal plane of imaging system 120. In some exemplary embodiments, primary imaging system 120 includes telecentric imaging between the SLM and the splitting element.

According to some embodiments of the present invention, a secondary imaging system 150 is used to focus sub-beams 195 onto a surface such as writable surface 160. Typically, secondary imaging system 150 includes a telecentric lens system. Telecentric lenses are designed so that all the chief rays of the beam impinge the surface substantially normally. Typically, sub-beams 195 impinge on the writable surface substantially in a normal direction, e.g. head-on. In some exemplary embodiments, either before or after passing through secondary imaging system 150, one or more redirecting elements 140 are used to change a direction of one or more sub-beams 195 and direct the sub-beams to a desired position on writable surface 160 and at a desired impinging angle. According to some embodiments of the present invention, a single element is used for redirecting and imaging. In some exemplary embodiments, the secondary imaging system 150 is a group of lenses that is shifted off-axis so that it also acts as a prism. In some exemplary embodiments, the order between the imaging element 150 and the redirecting element 140 is reversed. In some other exemplary embodiments, the redirecting element 140 may be interposed between two sub-elements of the imaging element 150.

According to some embodiments of the present invention, beam splitting element 130 and the redirecting element 140 are jointly operative to direct the sub-beams at a desired location and impinging angle, e.g. at normal incidence on writable surface 160. In some exemplary embodiments, in the absence of redirecting elements 140, the beams may not impinge at normal incidence. But if the distance between the splitting elements and the panel is large enough, this angle can be made practically small enough in order to be used for direct imaging.

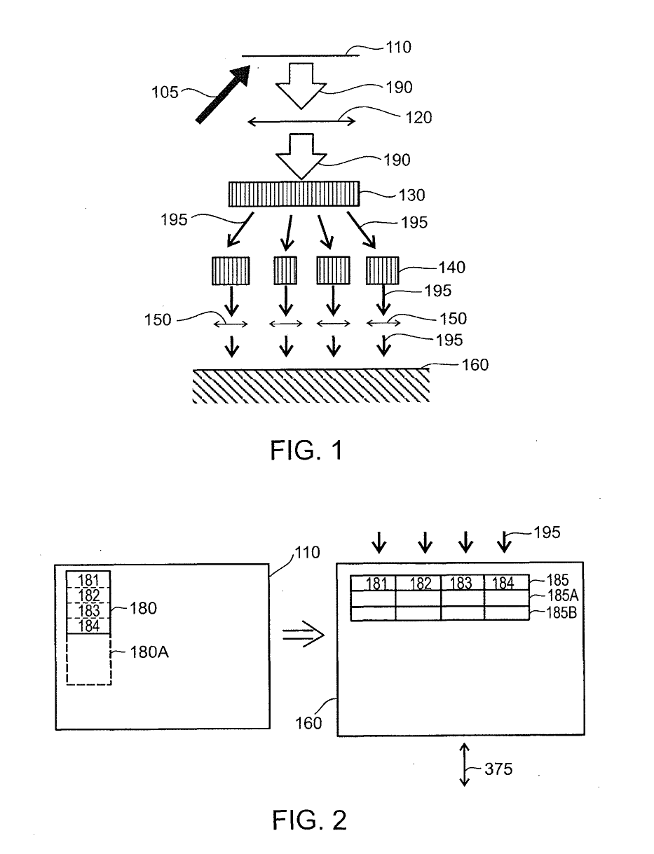

Reference is now made to FIG. 2 showing a simplified schematic diagram of an image divided into defined sections, e.g. image slices, each section directed to a different destination in accordance with some embodiments of the present invention. Typically, in known systems, a spatially modulated light beam 190 impinges on a writable surface 160 to form an imaged area 180. As the writable surface advances in the scan direction 375 successive beams 190 impinge on the writable surface to form successive image areas, e.g. image area 180A. Typically, the imaged area 180 is narrow compared to the area of the surface to be scanned.

According to some embodiments of the present invention, an area 180 of SLM 110 is split into a plurality of sub-areas, e.g. sub-areas 181-184, by sub-beams 195 that are redirected to form an elongated image area 185 on a writable surface 160. In some exemplary embodiments, writable surface 160 advances in the scan direction 375 as successive sets of sub-beams 195 impinge on writable surface 160 to form successive image areas, e.g. image areas 185A, 185B. In such a manner a continuous image is constructed from a plurality of SLM images directed toward the writable surface over time. In some exemplary embodiments, image area 185 is elongated and scans a wider area as compared to image area 180. In accordance with some preferred embodiments of the present invention the rows and columns of imaged modulating elements contained in sub areas 181-184 are substantially parallel to each other.

In some exemplary embodiments, the writable surface is advanced in both the scan direction and the cross-scan direction perpendicular to the scan direction while creating a continuous image from a plurality of SLM images. In some exemplary embodiments, the 1×4 array of sub-beams is arranged on the writable surface so that the wider dimension of the array, e.g. including 4 sub-beams, is parallel to the cross-scan direction. In such a manner the number of sweeps required to scan the entire image is reduced or even eliminates the need for multiple sweeps.

Typically, during scanning, writable surface 160 advances in the scan direction 375, as a sequence of modulated sub-beams 195 impinge on writable surface 160 to form sequences of sub-images 181-184 until a continuous image is formed on substantially the entire writable surface 160. According to some embodiments of the present invention, the SLM is a DMD. In some exemplary embodiments, a single DMD is used to generate a single image with an aspect ratio other than the form factor of the DMD. In some exemplary embodiments, a single DMD is used to scan an image on a moving object.

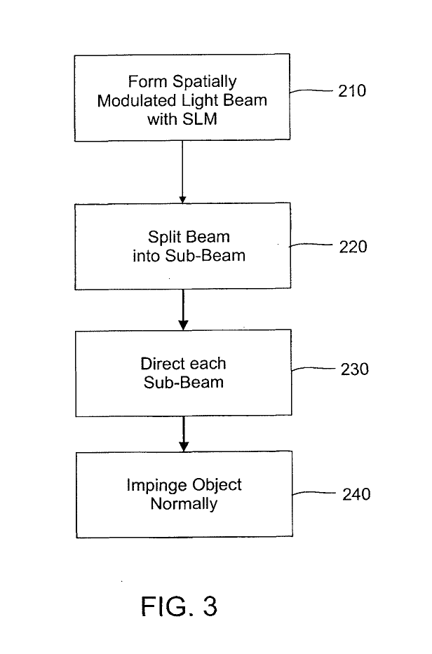

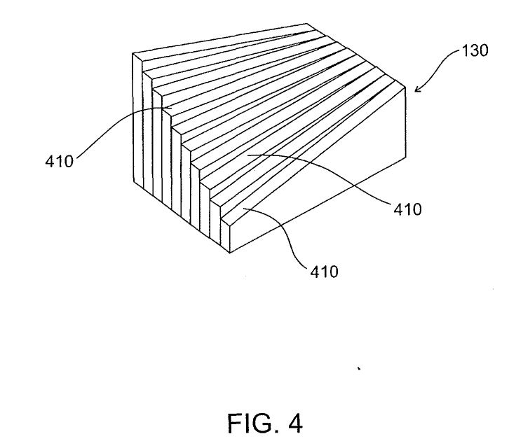

Reference is now made to FIG. 3 showing a simplified flow chart of an exemplary method for partitioning a spatially modulated light beam into sub-beams and directing each sub-beam to a desired destination and angle in accordance with some embodiments of the present invention. According to some embodiments of the present invention, a spatially modulated light beam is formed with an SLM and/or a plurality of SLMs (block 210). Each spatially modulated light beam is split into two or more sub-beams (block 220). Each sub-beam is directed to a target position on the writable surface (block 230). In some exemplary embodiments, each sub-image beam is conditioned to hit the writable surface at a perpendicular angle (block 240). According to some embodiments of the present invention, the method described in blocks 210—block 240 is used to scan a plurality of spatially modulated light beam on a moving writable surface to form a continuous image. According to some embodiments of the present invention, scanning a writable surface with a plurality of spatially modulated light beam is performed by repeating blocks 210-240 as the writable surface moves in a scan direction with respect to the scanning sub-beams.

According to some embodiments of the present invention, the system and methods described herein are directed toward DI of large panels of PCB with images created by DMDs. According to some embodiments of the present invention, the DMD scanning beam is split into sub-beams and each sub-beam is redirected to form an elongated thin scanning beam that is better configured for scanning large areas. For example, by increasing the length of the scanning beam the number of sweeps required to scan the width panel is reduced. Although each sweep may take more time because less exposure power is now available at each slice, the overall time of manufacture is reduced by minimizing the number of back and forth movements required in multiple sweeps. Typically, during scanning it is desired to reduce the number of sweeps required to scan the PCB for the purpose of reducing time of manufacture and cost of materials and thereby reduces the overall cost.

Reference is now made to FIG. 4 showing an exemplary beam splitting element in accordance with some embodiments of the present invention. According to some embodiments of the present invention, splitting element 130 is a single element including a plurality of mirror surfaces 410, each surface configured to reflect a single sub-beam in a direction different from the other sub-beams. In other exemplary embodiments, splitting element 130 is constructed from a plurality of elements. Typically, the shape and dimension of each surface 410, defines the shape, dimension of each sub-beam. In some exemplary embodiments, splitting element 130 has an aspect ratio substantially similar to the aspect ratio of the SLM, e.g. DMD generating the spatially modulated light beam to be split. In some exemplary embodiments, splitting element 130 includes 10 surfaces 410 that functions to split a rectangular SLM image into 10 slices such that each slice includes the widest dimension of the SLM image. In some exemplary embodiments, each plane reflects a plurality of rows of a DMD image.

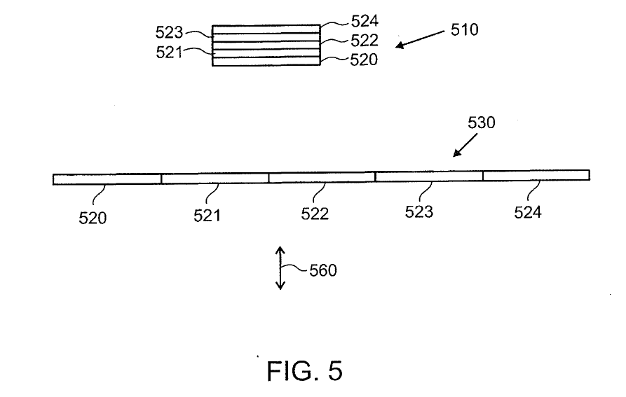

Reference is now made to FIG. 5 showing a simplified schematic diagram of an image divided into slices and arranged to form an elongated rectangular image on a writable surface in accordance with some embodiments of the present invention. In some exemplary embodiments, an SLM image 510 is divided into 5 sub-images 520-524, where each sub-image is a slice of SLM image 510, such that each slice includes the longest dimension of SLM image 510. Using the optical systems and methods described herein, the SLM image is split and arranged on a writable surface as a 1×5 array of sub-images to create a long thin image strip 530 from block shaped image 510. In some exemplary embodiments, strip image 530 is perpendicular to scan direction 560. By altering the dimension of the image created by the SLM in such a manner, the area scanned in a single sweep is increased by 5 fold. In some exemplary embodiments, strip 530 is a continuous strip with no gaps between slices 520-524. According to embodiments of the present invention, image data generated by the SLM is configured to be split and redirected in a pre-defined manner.

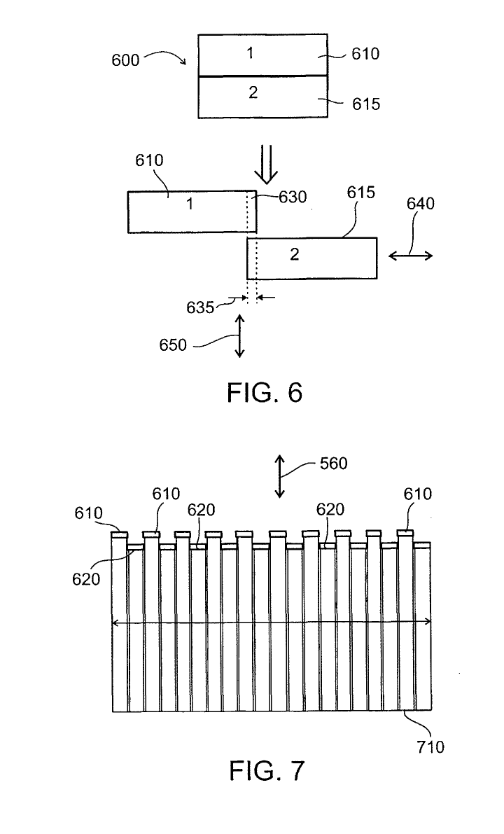

Reference is now made to FIG. 6 showing a simplified schematic diagram of image slices arranged on a writable surface to form an overlapping region in the cross-scan direction in accordance with some embodiments of the present invention. In some exemplary embodiments, a spatially modulated light beam is split into two sub-beams 610 and 615. In some exemplary embodiments, each sub-beam 610 and 615 corresponds to spatially modulated light reflected off a plurality of rows on a DMD. Sub-beams are directed on the writable surface in a checkered fashion including an overlapping region in the cross-scan direction 640. In some exemplary embodiments, during scanning in scan direction 650, overlapping region 630 in sub-beam 610 over-writes over-lapping region 635 in sub-beam 615. In some exemplary embodiments, the overlapping regions between sub-beams 610 and 615 increase matching and connectivity between areas scanned by the sub-beams.

Reference is now made to FIG. 7 showing a simplified schematic diagram of slices from two DMDs arranged to scan a full width of a panel in accordance to some embodiments of the present invention. According to embodiments of the present invention, each DMD is optically divided into 10 slices that are arranged in a staggered row where every other slice 620 is offset from its neighboring slices 610 in both scan and cross-scan direction to form a tooth-like pattern. In some exemplary embodiments, the gap between two aligned slices 610 is smaller than the length of a slice 620 so that part of the area scanned by slice 620 overlaps areas that where scanned by neighboring slices 610. As the scanned object moves with respect to the optical system, a continuous area may be scanned while avoiding gaps and mismatching between image slices.

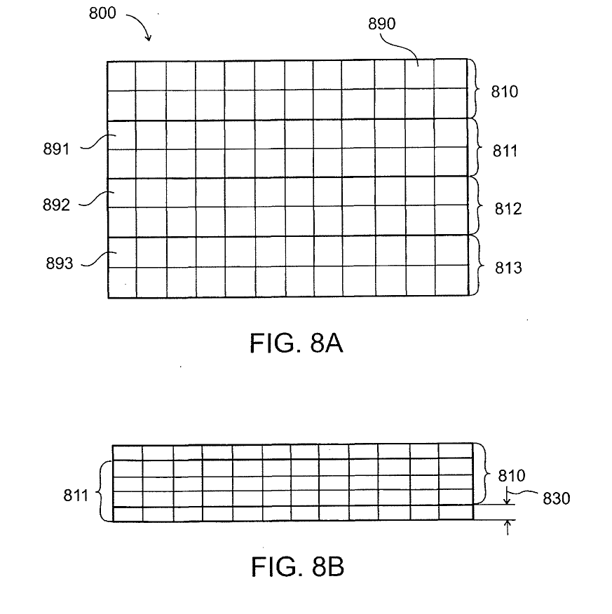

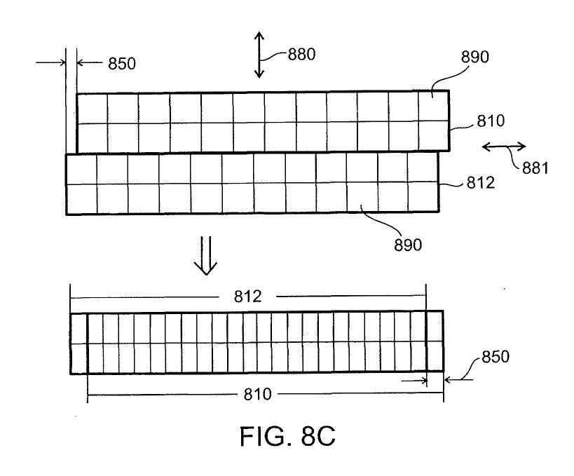

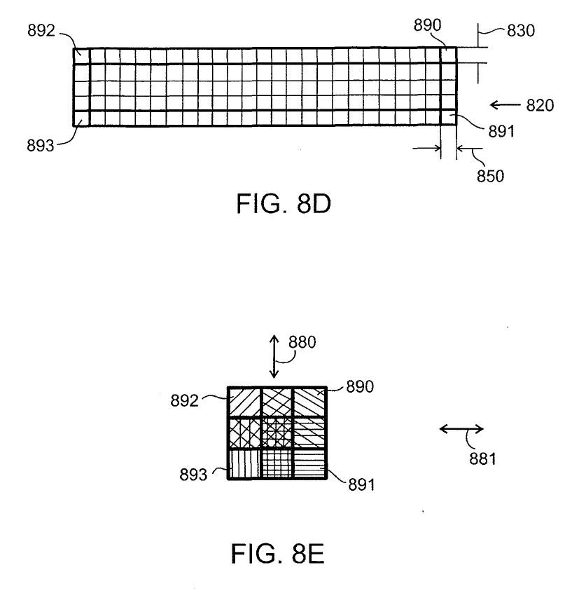

Reference is now made to FIGS. 8A-8E showing how re-distribution of sub-beams reflected from a DMD on a target surface is used to increase the resolution and/or the number of pixels per given area (pixel density) that can be reached when scanning an image with a spatially modulated beam. In FIG. 8A a simplified schematic diagram of a DMD image is divided into 4 image slices 810-813 in accordance with some embodiments of the present invention. For exemplary purposes, each image slice is shown to include 24 pixels in a 12×2 array, e.g. pixel 890 in image slice 810, pixel 891 in image slice 811, pixel 892 in image slice 812 and pixel 893 in image slice 813. Typically, an image slice from a DMD may include a much larger array of pixel rows, e.g. 768/M, 1024/M, 1080/M or 1920/M where M equals the number of image slices.

FIG. 8B shows a simplified schematic diagram of two image slices from the DMD projected on a target surface with a half a pixel shift in the scan direction in accordance with some embodiments of the present invention. In some exemplary embodiments, a first image slice 810 is projected on a target surface at time T₁ with first spatially modulated image information. At a certain delay time ΔT a second exposure may be made with same image slice 810, this time with second spatially modulated image information. Typically, the delay ΔT will correspond to a DMD element shift of N+½ elements when N is an integer, e.g. half a DMD pixel shift in the scan direction, such as denoted by 830. In some exemplary embodiments, an additional image slice 811 is projected on the targeting surface so that two image slices 810 and 811 overlap with a half a pixel shift. In such a manner, the projected image has a pixel resolution in the scan direction that is double than pixel resolution of the DMD. In some exemplary embodiments, during scanning, images defined on a first half of a DMD area are projected on a moving surface at a pre-defined frequency, and images defined on the second half of the DMD area are projected at the same pre-defined frequency but with a delay corresponding to half a pixel shift. Other resolutions in the scan direction can be achieved by adjusting the number and periods of the delays. For example, the pixel resolution in the scan direction can be tripled by projecting the DMD image using two delays, each delay corresponding to one third a DMD pixel shift.

FIG. 8C shows a simplified schematic diagram of two image slices from the DMD projected on a target surface with a half a pixel shift in the cross-scan direction in accordance with some embodiments of the present invention. In some exemplary embodiments, two image slices 812 and slice 810 are projected on the target surface one behind the other with respect to the scan direction 880 with a lateral shift 850 between them in the cross-scan direction 881 where the shift is equivalent to the length of half a DMD mirror element. During scanning, the target surface advances in the scan direction 880 and pixels from one image slice 810 are projected between pixels from another image slice 812. In such a manner, the projected image has a pixel resolution in the cross-scan direction that is double than pixel resolution of the DMD.

FIG. 8D shows a simplified schematic diagram of the four image slices from the DMD projected on a target surface with a half a pixel shift in both the scan and cross-scan direction in accordance with some embodiments of the present invention. According to embodiments of the present invention, image 820 is constructed from image slices 810 and 812 overlapping image slices 811 and 813 respectfully with a half a pixel shift in the scan direction and from image slices 810 and 811 overlapping image slices 812 and 813 respectfully with a half a pixel shift in the cross-scan direction. In such a manner, the projected image in area 820 has a pixel resolution in both the cross-scan direction and the scan direction that is double than pixel resolution of the DMD. In other exemplary embodiments other size shifts are used, e.g. ⅓ DMD element shifts to achieve other resolutions during imaging. In some exemplary embodiments, resolution is increased only in one direction, e.g. cross-scan direction or scan direction, and/or different resolutions are used in each direction.

Reference is now made to FIG. 8E showing a simplified schematic diagram of overlap on the pixel level in response to half a pixel shift in the scan and cross-scan direction of four image slices in accordance with some embodiments of the present invention. In some exemplary embodiments, pixels 890 and 892 are shifted from pixels 891 and 893 by a half a pixel in the scan direction 880 while pixels 890 and 891 are shifted from pixels 892 and 893 by a half a pixel in the cross-scan direction 881.

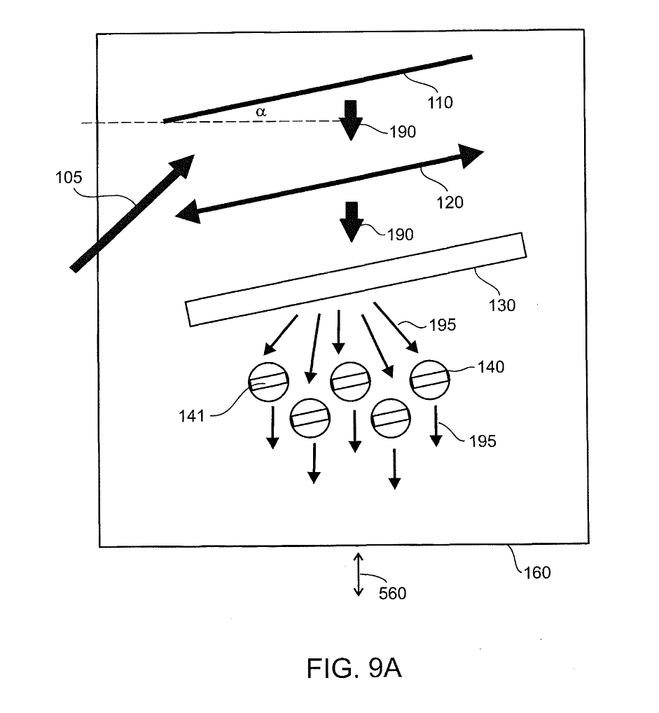

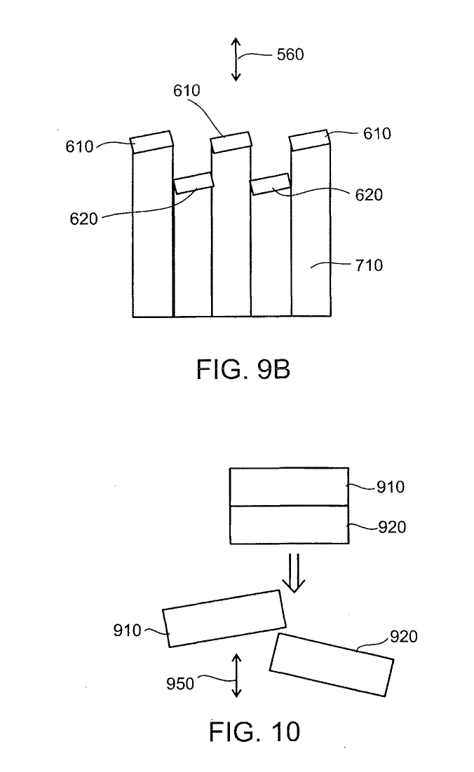

Reference is now made to FIG. 9A showing a simplified schematic diagram of an optical system for splitting a spatially modulated beam that is angled with respect to the scan and cross-scan direction into defined angled sub-beams in accordance with some embodiments of the present invention. According to some embodiments of the present invention, a spatially modulated beam 190 is formed when incident beam 105 impinges on SLM 110. According to some embodiments of the present invention SLM 110 is angled with respect to a cross-scan direction at a pre-defined angle α, e.g. at angle between 0-15 degrees.

Optionally, beam 190 passes through a primary imaging system 120 that re-images SLM 110 onto a splitting element 130. According to some embodiments of the present invention, splitting element 130 is positioned so that it is parallel with SLM 110, e.g. angled at pre-defined angle α with respect to the cross-scan direction. Beam 190 is reflected or refracted off beam splitting element 130 and is divided into a plurality of sub-beams 195. According to some embodiments of the present invention, due to the parallel alignment between angled SLM 110 and angled splitting element 130, each of sub-beams 195 are parallel to each other and parallel to beam 190 and angled at the pre-defined angle α with respect to the cross-scan direction.

According to some embodiments of the present invention, redirecting elements 140 are operative to direct each of sub-beams 195 and/or image slices 141 to impinge scanning surface 160 normally. In some exemplary embodiments, the order between the splitting element 130 and the redirecting element 140 is reversed. According to some embodiments of the present invention, the position and orientation of redirecting elements 140 is such that it does not alter the angle of sub-beams 195 with respect to the scan direction measurable from surface 160. According to some embodiments of the present invention, orientation of the rows of SLM 110, splitting element 130 and redirecting elements 140 are such that beam 190 reaching splitting element 130 and sub-beams 195 exiting redirecting elements 140 are substantially parallel at writing surface 160. In some exemplary embodiments, folding minors are inserted in the optical path of the sub-beams without changing the nature of the parallelism while directing the sub-beams so that they impinge the surface head-on, e.g. at normal incidence.

According to some embodiments of the present invention, the beam splitting element is operative to direct the sub-beams to a desired position on writable surface 160. In some exemplary embodiments, sub-beams are directed to surface 160 in two staggered rows parallel to the cross-scan direction as exemplified in FIGS. 9A and 9B, and such that there is no dead zones during scanning. As is well known in the art scanning at an angle provides for increasing the resolution, e.g. addressing pixel density, provided by each image slice since the projected images of the modulating elements in each successive row are slightly offset with respect to an adjacent row in the cross-scan direction. As is also well known in the art, scanning at an angle provides the necessary overlap between the partial exposures generated by each modulating element to ensure smooth pattern edges.

Reference is now made to FIG. 9B showing a simplified schematic diagram of image slices from a DMD that are angled with respect to the scan and cross-scan direction arranged to scan a width of a panel in accordance to some embodiments of the present invention. According to embodiments of the present invention, an SLM is optically divided into 5 slices that are arranged in a staggered row where every other slice 620 is offset from its neighboring slices 610 in both scan and cross-scan directions to form a tooth-like pattern, e.g. the 5 slices are arranged in two sub-rows. According to some embodiments of the present invention, slices 610 and 620 are angled with respect to scan direction 560, creating regions of gradual partial exposure at both ends of each slice. In some exemplary embodiments, the gap between two horizontally aligned slices 610 is smaller than the projected width of a slice 620 so that part of the area scanned by slice 620 overlaps areas that where scanned by neighboring slices 610. As the scanned object moves with respect to the optical system, a continuous area 710 may be scanned while avoiding gaps and mismatching between image slices.

According to some embodiments of the present invention, during calibration, one or more of the splitting element and redirecting mirrors elements are adjusted to provide the proper positioning, orientation and impinging angle on the surface, e.g. the photoresist. In some exemplary embodiments, during calibration the SLM is adjusted, e.g. oriented. For example, calibration of the redirecting elements may provide directing the subs-beams so that there is no dead zone and so that they all impinge normally to a photoresist surface. According to some embodiments of the present invention, during calibration, splitting element 130 is adjusted so that the orientation of the sub-beams with respect to the scan direction is the same as the orientation of the SLM with respect to the scan direction. In some exemplary embodiments, a fine tuning of the rotation of the SLM is operative to rotate the sub-beams altogether, at the risk that some lines of the SLM will not be entirely imaged on the splitting mirrors.

Reference is now made to FIG. 10 showing a simplified schematic diagram of sub-beams arranged on a writable surface at different angles with respect to the cross-scan direction in accordance with some embodiments of the present invention. According to some embodiments of the present invention, the optical system and methods described herein can be used to optically position sub-beams in different positions on the writable surface as well as to optically position sub-beams in different angles on the writable surface.

In some exemplary embodiments, a spatially modulated beam is divided into a plurality of sub-beams, e.g. beams 910 and beam 920 and sub-beam is imaged on the surface at an angle with respect to the scan direction 950. Rotation of the sub-beams is provided without requiring physically rotating the SLM, e.g. DMD. Typically, positioning the slices at an angle increases the pixel concentration in the angled direction and therefore increases the resolution of the image in that angled direction. The distance between the pixels in diagonal direction is larger than the distance between pixels in the horizontal and vertical direction. In some exemplary embodiments, the angle of the sub-beams is defined based on the details of the image. For example, if an image includes details oriented along one or more specific angles, sub-beams may be directed along those angles.

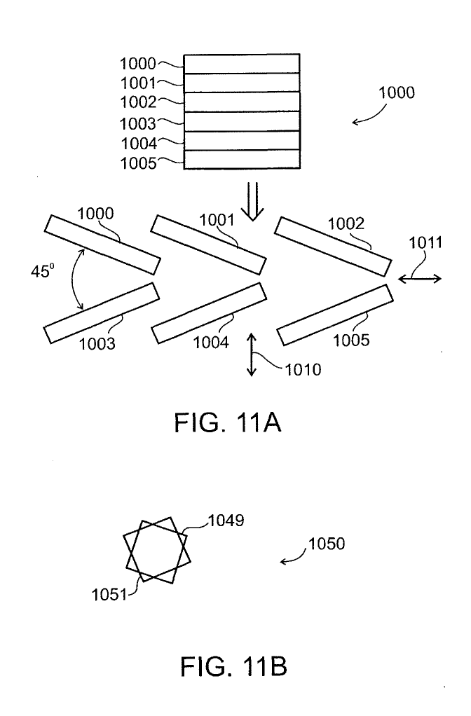

Reference is now made to FIG. 11A showing a simplified schematic diagram of two sets of sub-beams scanned on a writable surface with a 45 degree angle between them in accordance with some embodiments of the present invention. According to some embodiments of the present invention, angling of the sub-beams at different angles that cross each other during scanning is used to increase the resolution that can be reached when scanning an image including rounded edges and/or including patterns that are generally not parallel to the scanning or cross-scan direction. According to some embodiments of the present invention, spatially modulated light beam 1000 is divided into a plurality of sub-beams, e.g. slices 1000-1005. In some exemplary embodiments, each sub-beam corresponds to a slice of a DMD. In some exemplary embodiments, the sub-beams are offset from each other in the scan 1010 and cross-scan 1011 direction to form a 2×3 array. In addition, a first set of sub-beams, e.g. sub-beams 1000-1002 scanned on the writable surface at a first angle with respect to the cross-scan direction followed by the second set of sub-beams, e.g. sub-beams 1003 and 1005 scanned on the writable surface at a second angle, e.g. 45 degree angle from the first set of slices. During scanning in scan direction 1010, data from sub-beams 1000-1002 overlap data from sub-beams 1003-1005. Each area is scanned by two slices crossing each other so that the resolution in each area is increased.

Reference is now made to FIG. 11B showing a simplified schematic diagram of a resultant pixel imaged on a target surface constructed from two angled DMD pixels in accordance with some embodiments of the present invention, each pixel on the writable surface, e.g. pixel 1050 is constructed from two pixels on a DMD, e.g. pixel 1049 from slice 1000 and pixel 1051 from slice from slice 1003. In other exemplary embodiments, a plurality of sub-beams is arranged in a 3×3 array with a 30 degree angle between slices of each of the rows and each pixel on the writable surface is constructed from 3 pixels on the DMD.

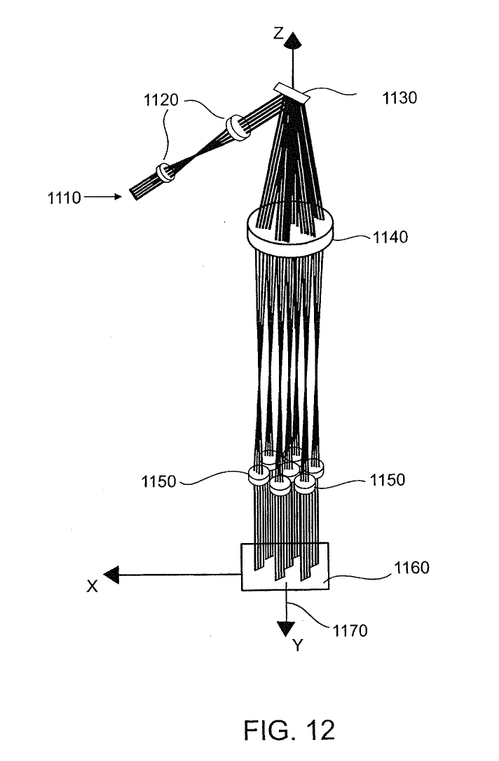

Reference is now made to FIG. 12 showing a simplified schematic diagram of an optical system for splitting a spatially modulated beam into a plurality of sub-beams that are arranged to form a compact polygonal with hexagonal/honeycomb shape on a target object in accordance with some embodiments of the present invention. As would be apparent to those skilled in the art, although the DMD has a rectangular shape, once the sub-beams derived from the DMD pass through an optical system, their shape becomes rounded in accordance with the apertures of the optical elements used along the optical path. In some exemplary embodiments, the overall optical system becomes more compact by scanning the sub-beams using a hexagonal/honeycomb arrangement. In some exemplary embodiments, an image formed by a DMD 1110 is focused onto a reflective beam splitter 1130 with a set of telecentric lenses 1120. In some exemplary embodiments, beam splitter 1130 includes a splitting array of 7 mirrors. In other exemplary embodiments, prisms replace the mirrors. Beam splitter 1130 divides the spatially modulated light into 7 sub-beams, e.g. 7 slices from a DMD. In some exemplary embodiments all 7 sub-beams pass through a large lens 1140 and then through separate lenses to focus each of the beams onto the writable surface 1160 as the target advances in the scan direction 1170 with respect to the sub-beams. In some exemplary embodiments, lenses 1150 are tilted so that the beams are fully focused on the object plane.

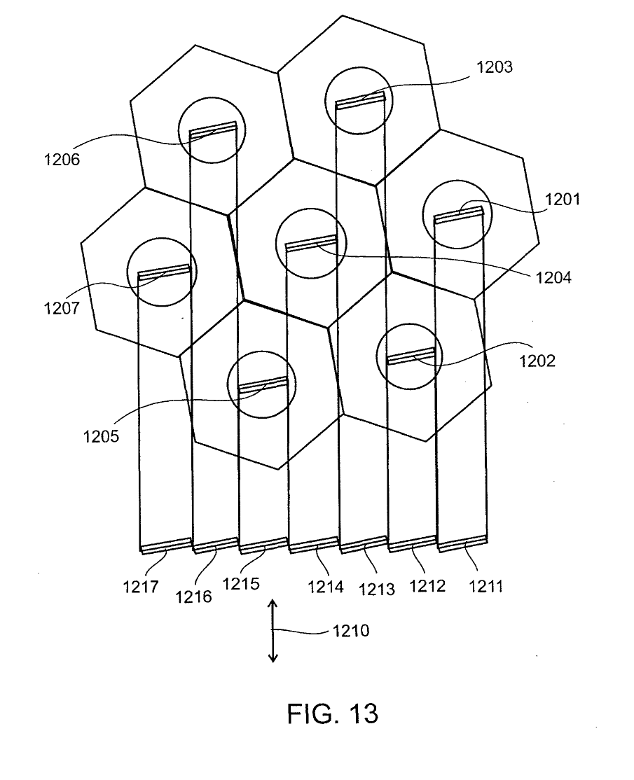

Reference is now made to FIG. 13 showing image slices scanned in compact polygonal form with a hexagonal/honeycomb arrangement in accordance with some embodiments of the present invention. In some exemplary embodiments, each of sub-beams 1201-1207 are positioned on the writable surface so that during scanning in the scan direction 1210 a full row is exposed without non-exposed areas formed between exposed areas. As scanning progresses and each of sub-beams 1201-1207 provide a projection on a same row, exposing regions 1211, 1212-1217 projected from sub-beams 1201-1207 respectively form a continuous exposure along a row without non-exposed areas formed between each of the projections. Since a distance related to the geometry of the honeycomb arrangement needs to be passed before obtaining continuous exposure, scanning is typically initiated position preceding a desired scanning area and is continued until each of sub-beams 1201-1207 scan the desired scanning length. As such the scanning distance for compact polygon scanning is typically increased by a pre-defined length above the length of a desired area for scanning.

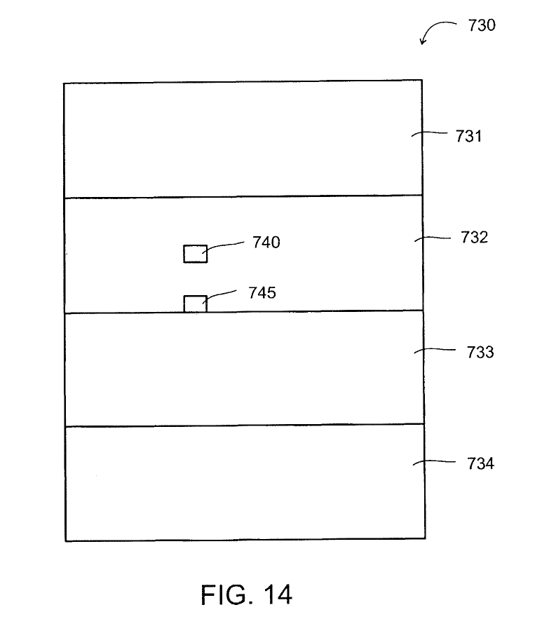

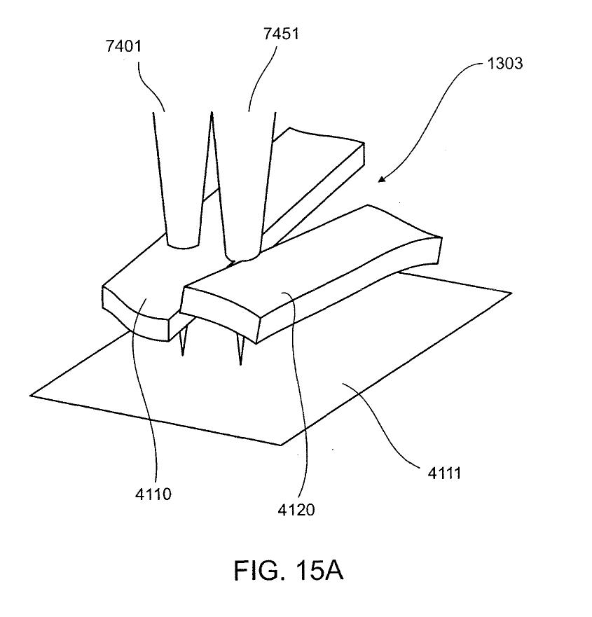

According to some embodiments of the present invention, the physical geometry of splitting element 130 may lead to vignetting and/or obstruction effects that may limit the number of lines that can be imaged from the SLM. Reference is now made to FIG. 14 showing a simplified schematic diagram of two modulating elements from an image slice on a DMD in accordance with some embodiments of the present invention. According to some embodiments of the present invention, an image on DMD 730 is divided by a splitting element into 4 image slices corresponding to image slices 731-734. According to some embodiments of the present inventions, modulating elements, e.g. element 745 near the border between two slices, e.g. slice 733 and 732 may not be imaged properly due to vignetting and/or may not be distributed to the correct slice due to tolerances and/or obstruction from geometry of splitting element as compared to modulating elements, e.g. element 740 in the central portion of an image slice, e.g. slice 732.

Reference is now made to FIG. 14 showing a simplified schematic diagram of two modulating elements from an image slice on a DMD in accordance with some embodiments of the present invention. According to some embodiments of the present invention, a DMD image 730 is split into a plurality of image slices, e.g. image slices 731-734. Typically each image slice includes a plurality of modulating elements distributed throughout the area of the slice, e.g. elements 740 and 745. The present inventors have found that modulating elements positioned around an edge of an image slice, e.g. element 745 may be lost or not be imaged properly as a result of the geometrical properties of the splitting element. According to some embodiments of the present invention, modulating elements positioned around the central region of each image slice, e.g. element 740, are more likely to be imaged properly after splitting as compared to elements positioned closer to the edge of the image slice, e.g. element 745. Improper imaging of pixels near edges of image slice typically leads to vignetting and exposure ambiguity.

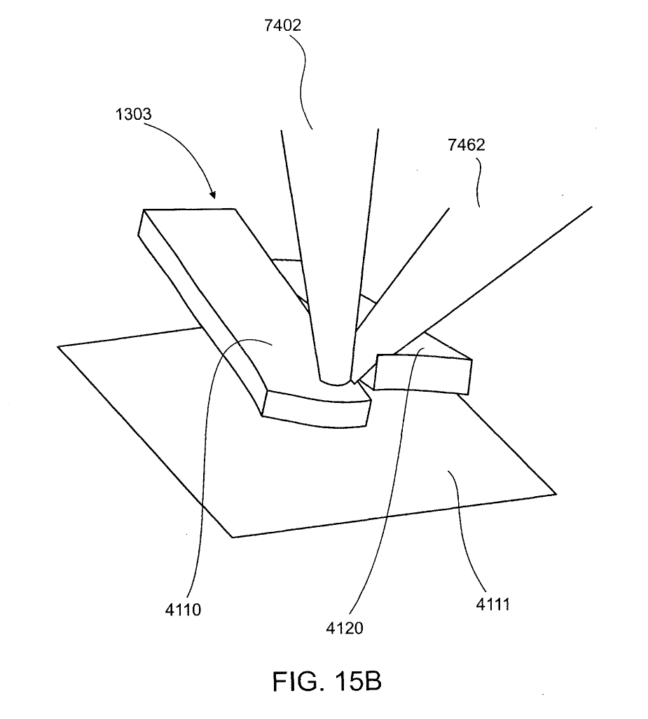

Reference is now made to FIG. 15A showing a simplified schematic diagram of projection of two modulating elements on a portion of a splitting element in accordance with some embodiments of the present invention. According to some embodiments of the present invention, splitting element 130 is straddled around a focal plane 4111 so that a portion of the splitting element falls directly on focal plane 4111 while other portions fall out of focal plane 4111, e.g. portion 1303. Ideally, all beams impinging on the splitting element should be in focus. In reality, since the splitting element includes a plurality of surfaces, some of the beams, e.g. modulating element beams 7401 and 7451 impinge the splitting element when out of focus. According to some embodiments of the present invention, a width of each surface of the splitting element corresponds to a width of an image slice so that all modulating element beams e.g. element beams 7401 and 7451 reflected from a single image slice, e.g. slice 732 (FIG. 14) impinge a single surface of the splitting element. However, due to modulating element beams impinging the surface of the splitting element above or below focal plane 4111, due to misalignment between the SLM and the splitting element and/or due to tolerances and/or due to the geometry of the splitting element, some of the beams partially and/or fully impinge a neighboring surface of the splitting element, e.g. surface 4120 instead of its designate surface, e.g. surface 4110. The result of modulating element beams partially and/or fully impinging a neighboring surface of the splitting element is loss of beam power, e.g. vignetting, as well as possible reflection toward an undesired position on the scan surface.

Reference is now made to FIG. 15B showing a simplified schematic diagram of reflections of a modulating element beam on a portion of a beam splitting element in accordance with some embodiments of the present invention. The present inventors have found that although a modulating element beam 7402 may impinge its designated surface 4110 of a splitting element, it may be obstructed by a neighboring surface 4111 when reflected off surface 4110, e.g. reflected beam 7462. Obstruction may be due to a difference in height between neighboring surfaces and due to proximity of the incident beam 7402 to an edge of surface 4110. Typically, obstruction of the beams around the edges causes vignetting leading to a reduction in a beam power for a particular modulating element as well as possible reflection toward an undesired position on the scan surface and exposure ambiguity. Although obstruction of the beams can be avoided by separating the splitting surfaces, defocus and therefore vignetting will be increased.

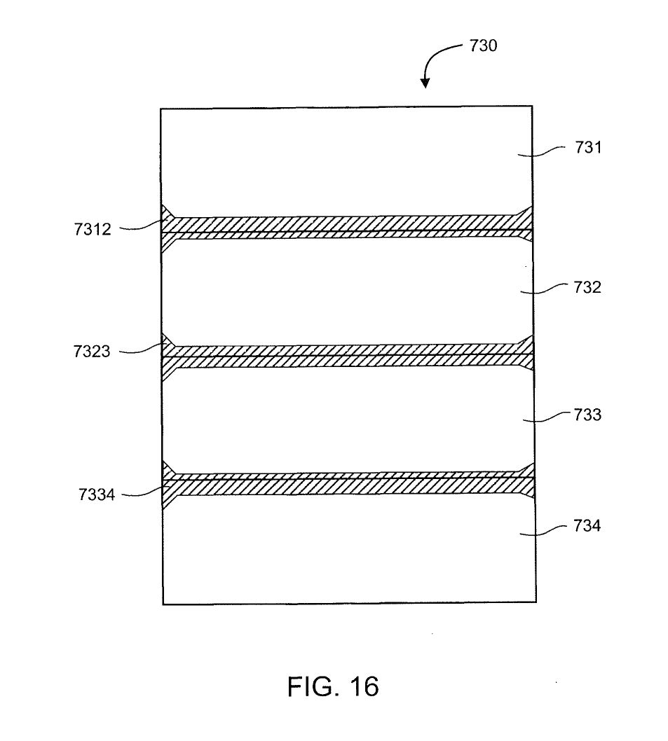

Reference is now made to FIG. 16 showing a simplified schematic diagram of areas around edges of image slices that are blanked in accordance with some embodiments of the present invention. According to some embodiments of the present invention, selective areas around edges of image slices are blanked to avoid ambiguity resulting from reflection of pixels to undesired positions on the scan surface as well as vignetting due to partial and/or full obstruction. As used herein, blanking a modulating element is equivalent to turning an element off. According to some embodiments of the present invention, a DMD image 730 includes areas that are blanked, e.g. areas 7312, 7323, and 7334, along edges of image slices 731-734. According to some embodiments of the present invention approximately 20-30 rows of the DMD per image slice are blanked resulting in approximately 5%-10% loss of energy due to blanking, e.g. for an image divided into 4 slices. Typically, the blanking pattern is not necessarily linear.

According to some embodiments of the present invention, the blanked area in each of the slices is defined such that each slice includes a substantially identical amount of usable area, e.g. area that is not blanked. In addition, some applications require a given uniformity of energy reaching the scan surface so that pixels and/or pixel lines that cannot contribute enough energy are not usable. According to some embodiments of the present invention, the blanking pattern of each slice is designed such that each image slice reflects an equal and uniform amount of energy integrated along the scan direction, e.g. the power output for each of the slices is the same.

According to some embodiments of the present invention, the blanked pattern is defined so that the usable area of each slice is maximized while exposure ambiguity is minimized. According to some embodiments of the present invention, the number of total usable pixels in an image slice is maximized by providing more blanking on the edges of slices that have only one edge neighboring another slice and reducing blanking on slices that have two edges neighboring another slice. For example, blanking area 7334 is biased toward image slice 734 that has only one neighboring slice 733 and blanking area 7312 is biased toward image slice 731 having only one neighboring image slice 732. According to some embodiments of the present invention, during calibration, the position and orientation of the splitting element is fine tuned so that the blanked areas on the SLM prevent ambiguity resulting from the dimensions of the splitting element.

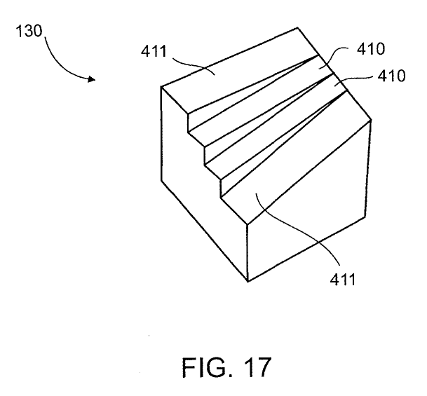

Reference is now made to FIG. 17 showing a simplified schematic diagram of a modified splitting element in accordance with some embodiments of the present invention. According to some embodiments of the present invention, splitting element 130 includes a plurality of splitting surfaces that vary in width. According to some embodiments of the present invention, the two outer splitting surfaces 411 are wider than splitting surfaces 410 that are sandwiched between two neighboring splitting surfaces and generally larger than the corresponding size of the image slice. According to some embodiments of the present invention, expanding the area of the two outer splitting surfaces provides for increasing, e.g. maximizing beam energy reflected from splitting surfaces 411. In some exemplary embodiments, expanding the area of the two outer splitting surfaces provides for receiving modulating element beams that may otherwise be missed due to the surface falling out of the focal plane. This is specifically possible for the outer surfaces 411 since expanding the area of the outer splitting element doesn't obstruct the other slices. According to some embodiments of the present invention, a blanking pattern is manipulated to equalize the beam energy from each of the slices. For example, a blanking area may be biased toward outer surfaces 411 as described herein.

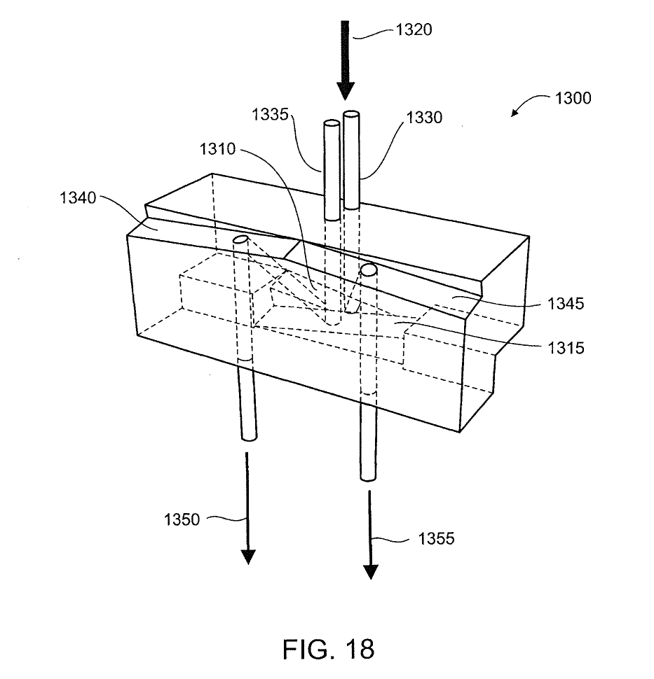

Reference is now made to FIG. 18 showing a simplified monolithic block that functions to split a spatially modulated light beam into sub-beams and direct the sub-beams to a specified direction in accordance with some embodiments of the present invention. In some exemplary embodiments, a single or compound optical element can be used to split the spatially modulated beam into sub-beams and direct the sub-beams to a desired direction and position. In some exemplary embodiment, optical element 1300 includes a plurality of reflecting surfaces 1310 and 1315 for splitting spatially modulated light beam 1320 into two sub-beams 1330 and 1335. In some exemplary embodiments, optical element 1300 also includes reflecting surfaces 1340 and 1345 for directing sub-beams 1330 and 1335 through a single lens that images both beams onto the object in a desired position 1350 and 1355.

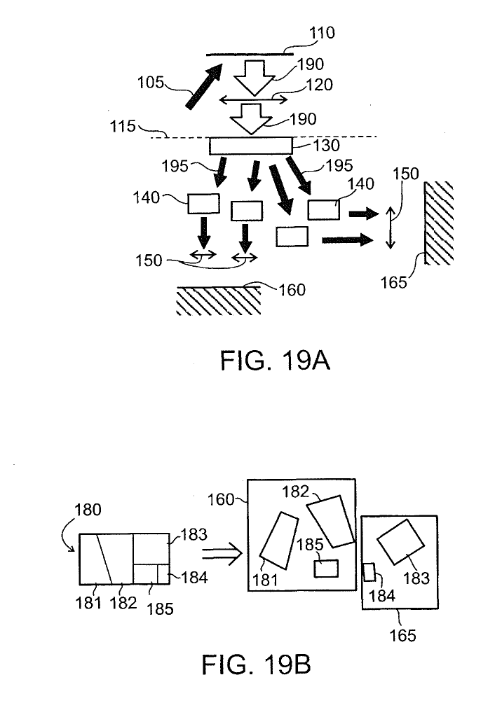

Reference is now made to FIG. 19A showing a simplified schematic diagram of an optical system for splitting a spatially modulated beam into defined sub-beams and directing at least a portion of the sub-beams to different destinations in accordance with some embodiments of the present invention. According to some embodiments of the present invention, a spatially modulated beam 190 is formed when incident beam 105 impinges on SLM 110. In some exemplary embodiments, SLM 110 is a DMD. Optionally, beam 190 passes through a primary imaging system 120 that re-images beam 190 onto the splitting element 130. Beam 190 is reflected or refracted off beam splitting element 130 to divide the beam into a plurality of sub-beams 195. In some exemplary embodiments, beam splitter 130 is constructed from mirrors, prisms, lenses or other optical elements that change the direction of the light.

In some exemplary embodiments, splitting element 130 is positioned on the focal plane of SLM 110. The present inventors have found that positioning the splitting element 130 on the focal plane reduces unusable parts of the SLM due to non-continuity between the basic elements of beam splitter 130. In some exemplary embodiments, positioning the beam splitting element 130 on and/or near the focal plane of the SLM, e.g. straddling the splitting element 130 around the focal plane, reduces vignetting effects and avoids beam mixing. Typically, when primary imaging system 120 is included, beam splitting element 130 is positioned on the focal plane 115 of imaging system 120. In some exemplary embodiments, primary imaging system 120 includes telecentric imaging between the SLM and the splitting element.

According to some embodiments of the present invention, a secondary imaging system 150 is used to focus sub-beams 195 onto a target object, e.g. target object 160 and 165. Typically, secondary imaging system 150 includes a telecentric lens system to direct each of sub-beams 195 such that they fully impinge on the target object in a normal direction, e.g. head-on. In some exemplary embodiments, prior to passing through secondary imaging system 150, one or more redirecting elements 140 are used to change a direction of one or more sub-beams 195 and direct the sub-beams to a desired position and impinging angle on one of target objects 160 and 165 and/or toward different target objects, e.g. both target object 160 and target object 165. It is noted that the schematic embodiment shown in FIG. 19A can be applied to many known writing systems as well as to known, e.g. existing scanners.

Reference is now made to FIG. 19B showing a simplified schematic diagram of an image divided into defined sections, each section directed to a different destination in accordance with some embodiments of the present invention. According to some embodiments of the present invention, an image 180 generated by an SLM is split into a plurality of sub-images, e.g. sub-images 181-185. Each sub-image 181-185 can then be directed to one or more positions and/or can be rotated around the beam chief ray at a different angle. Optionally, a first portion of the sub-images, sub-images 181, 182, and 185 is imaged on a first target object 160 and while a second portion of the sub-images, sub-images 183, 184 is simultaneously imaged on a second target object 165. According to some embodiments of the present invention, the SLM is a DMD. In some exemplary embodiments, a single DMD is used to generate a plurality of images 181-185 imaged on one or more surfaces and at one more rotations. In some exemplary embodiments, a single DMD is used to generate a single image with a aspect ratio other than the form fact of the DMD.

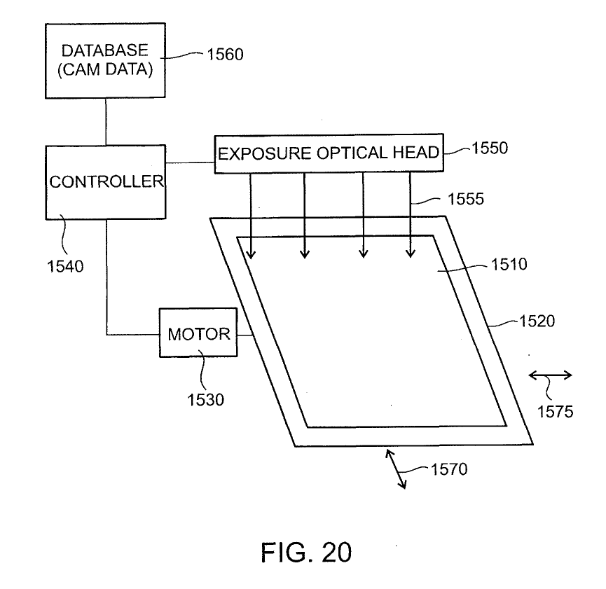

Reference is now made to FIG. 20 showing a simplified schematic diagram of a maskless lithography system for exposing a pattern on a PCB panel in accordance with some embodiments of the present invention. According to some embodiments of the present invention a PCB panel 1510 sits on a movable table 1520. Typically as exposure optical head 1550 exposes image patterns on photoresist coated PCB with a plurality of sub-beams 1555, motor 1530 controls movement of table 1520 in a linear scanning motion. Typically during scanning, motion actuator/encoder 1530 controls movement of table 1520 in the scan direction 1570. Optionally there may be provided a second motion actuator to move either the table 1520 or the optical head 1550 in the cross-scan direction 1575. According to embodiments of the present invention, controller 1540 controls the operation of the exposure optical head 1550 and the movement of table 1530 in accordance with a Computer Aided Manufacturing (CAM) writing data base 1560 typically stored in memory, e.g. disk files. In some exemplary embodiments, the primary direction of movement during scanning is in the scan direction. Although motor 1530 is shown to control movement of table 1520, it is noted that table 1520 may be stationary and scanner 1550 may advance in the scan and cross-scan directions during scanning. Optionally, one or more motors control movement of both table 1520 and scanner 1550 during scanning.

According to some embodiments of the present invention, exposure optical head 1550 includes one or more incident beam sources, one or more SLMs, e.g. DMD, one or more beam splitting elements, and one or more optical systems. Typically, the optical system includes one or more optical elements to optically direct sub-beams reflected off the splitting element to impinge photoresist layer of PCB panel 1510 perpendicularly. Optionally, exposure optical head 1550 includes one or more redirecting elements for altering direction of a sub-beam reflected from a beam splitting element. Optionally, altering directions of sub-beams include optically rotating one or more sub-beams with respect to cross-scan direction 1575.

Typically, controller 1540 provides a modulation signal to the SLM complying with the splitting of the modulated beam and the redirecting of the sub-beams. Typically, controller 1540 adjusts the modulation data rate and timing of exposure optical head 1550 with the speed of movement of table 1520 based on geometry and positioning of sub-beams 1555 on panel 1510 over time.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A method of scanning a pattern on a surface, the method comprising:
forming a first spatially modulated light beam including a pattern for writing on a surface;
splitting the first spatially modulated light beam into a plurality of sub-beams;
altering a spatial relationship between the plurality of sub-beams, thereby forming a second spatially modulated light beam; and
scanning the surface with the second spatially modulated light beam.

2. The method according to claim 1, wherein the scanning includes writing.

3. The method according to claim 1, wherein altering the spatial relationship between the plurality of sub-beams alters the aspect ratio of the first spatially modulated light beam.

4. The method according to claim 3, wherein altering the spatial relationship between the plurality of sub-beams provides a spatially modulated light beam that is elongated with respect to the first spatially modulated light beam.

5. The method according to claim 1, wherein the spatial relationship between the plurality of sub-beams is altered to provide over-lap between sub-beams in the cross-scan direction during the scanning.

6. The method according to claim 5, wherein the over-lap provides for writing the pattern with a resolution greater than a resolution provided by the first spatially modulated light beam.

7. The method according to claim 1, wherein the spatial relationship between the plurality of sub-beams is altered to form a plurality of rows of sub-beams that at least partially over-lap in a scan direction during the scanning.

8. The method according to claim 7, wherein the plurality of rows are shifted with respect to each other by a distance equivalent to width of half an SLM element.

9. The method according to claim 1, wherein the spatial relationship between the plurality of sub-beams is altered to form a plurality of columns of sub-beams that at least partially over-lap in a scan direction during the scanning.

10. The method according to claim 1, wherein the spatially relationship between the plurality of sub-beams is altered to form a compact polygonal spatial relationship.

11. The method according to claim 1 comprising altering angular orientation of at least a portion of the plurality of sub-beams.

12. The method according to claim 11, wherein the spatial relationship between the plurality of sub-beams is altered to form at least a first and a second row, wherein sub-beams of the first row have a first angular orientation and sub-beams of the second row have a second angular orientation different than the first angular orientation, and wherein the first row and the second row over-lap each other during scanning.

13. The method according to claim 12, wherein the difference between the angular orientation of sub-beams in the first and the second row is 45 degrees.

14. The method according to claim 1 comprising directing each of the plurality of sub-beams in a direction perpendicular to the surface.

15. The method according to claim 14, wherein each of the plurality of sub-beams is directed toward the surface with a telecentric lens.

16. The method according to claim 1, wherein splitting of the spatially modulated light beam into a plurality of sub-beams is provided by a plurality of reflective or refractive surfaces.

17. The method according to claim 16, wherein the plurality of reflective or refractive surfaces is provided on a single optical element.

18. The method according to claim 1, wherein the splitting of the spatially modulated light beam into a plurality of sub-beams and the altering of the spatial relationship between the plurality of sub-beams is provided by a single optical element including a plurality of surfaces.

19. The method according to claim 1, wherein the spatially modulated light beams are formed with a Digital Micro-mirror Device (DMD), wherein the DMD includes rows and columns of reflecting elements, wherein the rows contain more elements than the columns.

20. The method according to claim 19, wherein each of the plurality of sub-beams corresponds to light reflected from a plurality of neighboring rows of the DMD.

21. The method according to claim 20, wherein the spatial relationship between the plurality of sub-beams is altered from a first modulated light beam divided into an array of a plurality of rows to form the second spatially modulated light beam wherein the sub-beams are spatially arranged side by side to form at least one elongated row of modulated beams.

22. The method according to claim 21, wherein the sub-beams are optically rotated.

23. The method according to claim 22, wherein the second spatially modulated light beam is formed from at least two rows of sub-beams, wherein the first and second rows are shifted with respect to each other by half the length of one reflective element of the DMD.

24. The method according to claim 20, comprising blanking a portion of the DMD between the plurality of neighboring rows.

25. The method according to claim 24, wherein the portion of the DMD that is blanked corresponds to portion determined to suffer from vignetting or obstruction effects due to the splitting.

26. The method according to claim 20, wherein each of the plurality of sub-beams is reflected from the same number of neighboring rows.

27. The method according to claim 1, wherein the surface is a surface of a panel of a printed circuit board, wherein the width of the panel in the cross-scan direction is wider than the width of the first spatially modulated light beam.

28. The method according to claim 27 comprising scanning the width of the panel in the cross-scan direction during a single pass.

29. The method according to claim 1, wherein the surface advances in a scan direction during the scanning.

30. A system for scanning a pattern on a surface with a light beam comprising:
a light source configured to generate a beam for scanning a pattern on a surface;
a spatial light modulator configured for spatially modulating the beam to form a spatially modulated beam providing the pattern to be written on the surface;
a beam splitting element configured for spatially dividing the modulated beam into a plurality of sub-beams;
a scanner operative to scan a target object with the plurality of redirected sub-beams; and
a controller operative to provide a modulation signal to the SLM complying with the splitting of the modulated beam.

31. The system according to claim 30 comprising a redirecting element configured for altering a spatial relationship between the sub-beams and wherein the controller is operative to provide a modulation signal to the SLM complying with the redirecting of the sub-beams.

32. The system according to claim 30, wherein the beam splitting element is configured to alter the aspect ratio of the spatially modulated beam.

33. The system according to claim 30, wherein the beam splitting element is configured to provide a second spatially modulated beam that is elongated with respect to the spatially modulated beam.

34. The system according to claim 30, wherein the beam splitting element is configured for providing overlapping regions between sub-beams during scanning.

35. The system according to claim 30, wherein the spatially light modulator is a DMD, wherein the DMD includes rows and columns of reflecting elements.

36. The system according to claim 35, wherein the beam splitting element is configured to form each sub-beams from light reflected from a plurality of neighboring rows of the DMD, wherein the rows of the DMD are longer than the columns of the DMD.

37. The system according to claim 36, wherein a portion of the DMD between the plurality of neighboring rows is blanked.

38. The system according to claim 37, wherein the portion of the DMD that is blanked corresponds to portion determined to suffer from vignetting or obstruction effects due to splitting of the modulated beam.

39. The method according to claim 37, wherein the portion corresponds to 20 to 30 rows of the DMD.

40. The method according to claim 36, wherein each of the plurality of sub-beams is reflected from the same number of neighboring rows.

41. The system according to claim 30, wherein the beam splitting element includes a plurality of reflective or refractive surfaces, each reflective or refractive surface reflecting one of the plurality of sub-beams.

42. The system according to claim 41, wherein the plurality of reflective or refractive surfaces are arranged in a row and wherein the reflective or refractive surfaces arranged in the beginning and end of the row have a larger surface area than the surface area of the reflective or refractive surfaces arranged in the middle of the row.

43. The system according to claim 30 comprising an imaging system configured for focusing each sub-beam onto the target object.

44. The system according to claim 43, wherein the imaging system includes at least one telecentric lens for directing each of the plurality of sub-beams on the target object in a direction perpendicular to the target object.

45. The system according to claim 30, wherein the beam splitting element is straddled on a focal plane of the spatial light modulator.

46. The system according to claim 30 comprising a primary imaging system configured for focusing the spatially modulated light beam on the beam splitting element.

47. The system according to claim 46, wherein the beam splitting element is positioned on a focal plane of the primary imaging system.
